(19) United States
(12) Patent Application Publication
(10) Pub. No.: US 2026/0212696 A1
(43) Pub. Date: Jul. 23, 2026

(54) DNA FINGERPRINT SCANNER AND AUTHENTICATOR

(71) Applicant: Robert Whitfield, Los Angeles, CA (US)

(72) Inventor: Robert Whitfield, Los Angeles, CA (US)

(21) Appl. No.: 19/027,192

(22) Filed: Jan. 17, 2025

(51) Int. Cl. G06V 40/12; G06F 21/32

(52) U.S. Cl. CPC G06V 40/1365; G06F 21/32

(57) ABSTRACT

Systems, apparatuses, and methods provide for processing for DNA fingerprint scanner systems. Such a DNA fingerprint scanner includes a body fluid DNA sampler, a printed DNA sampler, and a DNA analyzer. The body fluid DNA sampler is to receive body fluid. The printed DNA sampler is to sample a printed DNA infused fingerprint certificate. The DNA analyzer is coupled to the body fluid DNA sampler and the printed DNA sampler. The DNA analyzer is to determine DNA sequencing of the body fluid and the printed DNA infused fingerprint certificate.

### TECHNICAL FIELD

Embodiments generally relate to fingerprint scanner systems. More particularly, embodiments relate to deoxyribonucleic acid (DNA) fingerprint scanner systems.

### BACKGROUND

Document authenticity verification is often important in financial transactions. Such authenticity may be established through signature verification or other means. However, such authenticity needs to have a verification at such a certainty that signature verification cannot provide.

### BRIEF DESCRIPTION OF THE DRAWINGS

Various examples will be described below by referencing the following drawings, in which:

FIG. 1 is a diagram illustrating a DNA fingerprint scanner according to an example;

FIG. 2 is a schematic diagram illustrating the DNA fingerprint scanner according to an example;

FIG. 3 is a diagram illustrating a DNA infused fingerprint certificate according to an example;

FIG. 4 is an illustration of a flowchart of an example method for operating a DNA fingerprint scanner according to an example;

FIG. 5 is an illustration of a flowchart of an example method for transforming an interest-bearing loan into a hybrid asset-backed security according to an example;

FIG. 6 is a block diagram illustrating a computer program product according to an example;

FIG. 7 is a block diagram illustrating an example fluid delivery apparatus according to an example; and

FIG. 8 is a block diagram illustrating a hardware apparatus including a semiconductor package according to an example.

### DETAILED DESCRIPTION

As will be described in greater detail below, systems, apparatuses, and methods described herein provide DNA fingerprint apparatus for verifying the validity of certified documents. In some implementations, such a DNA fingerprint apparatus includes a body fluid DNA sampler, a printed DNA sampler, and a DNA analyzer. The body fluid DNA sampler is to receive body fluid. The printed DNA sampler is to sample a printed DNA infused fingerprint certificate. The DNA analyzer is coupled to the body fluid DNA sampler and the printed DNA sampler. The DNA analyzer is to determine DNA sequencing of the body fluid and the printed DNA infused fingerprint certificate.

As will be described in greater detail below, such DNA fingerprint scanners may be utilized to facilitate transactions involving transforming an interest-bearing loan into a hybrid asset-backed security to offer a 0% or below-market interest rate loan.

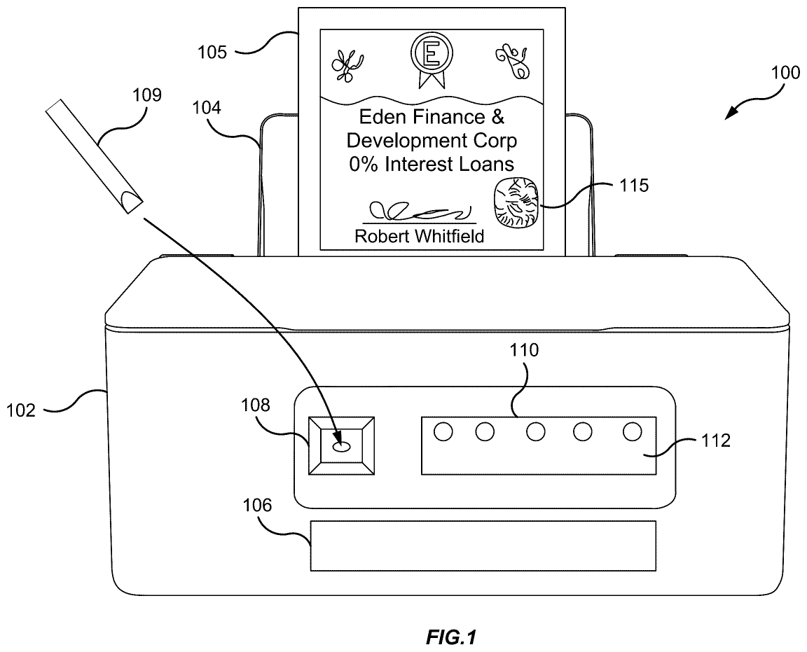

FIG. 1 is a diagram illustrating a DNA fingerprint apparatus 100 according to an example. As illustrated, DNA fingerprint apparatus 100 includes a housing 102, a feed tray 104, an outlet port 106, a body fluid DNA sampler 108, and a user interface 110.

In some implementations, the feed tray 104 is configured to hold and guide a document 105 into the housing 102. Similarly, the outlet port 106 is configured to hold and guide the document 105 as it exits the housing 102.

In some examples, the body fluid DNA sampler 108 is configured to receive a test strip 109 or the like. For example, the test strip 109 includes a DNA sample and the body fluid DNA sampler 108 is configured to receive the DNA sample from the test strip 109. The body fluid DNA sampler 108 is configured to receive either a blood-type DNA sample or a saliva-type DNA sample. In some implementations a single body fluid DNA sampler 108 is configured to receive both blood-type DNA samples and a saliva-type DNA samples. In other implementations body fluid DNA sampler 108 will include a first sampler configured to receive a blood-type DNA sample and a second sampler configured to receive a saliva-type DNA sample.

The user interface 110 may include a touch screen 112. Additionally, or alternatively the user interface 110 may include a series of control buttons, the like, and/or combinations thereof. In some examples, the touch screen 112 is configured to scan a fingerprint of a user's finger.

As will be discussed in further detail below, document 105 may include a DNA infused fingerprint certificate 115. Such a DNA infused fingerprint certificate 115 is a printed reproduction of a user's fingerprint using DNA infused ink. The DNA fingerprint apparatus 100 is configured to print such a DNA infused fingerprint certificate 115 onto document 105. Additionally, or alternatively, the DNA fingerprint apparatus 100 is configured to scan such a DNA infused fingerprint certificate 115 from document 105 to verify both the user's fingerprint and user's DNA.

In some implementations, the DNA fingerprint apparatus 100 includes both a DNA fingerprint printer (e.g., to print a hybrid asset-backed security with the DNA infused fingerprint certificate) and a DNA fingerprint scanner (e.g., to scan a hybrid asset-backed security with the DNA infused fingerprint certificate) formed as a single apparatus. In other implementations, the DNA fingerprint apparatus 100 includes a separate unit for a DNA fingerprint printer and a separate unit a DNA fingerprint scanner.

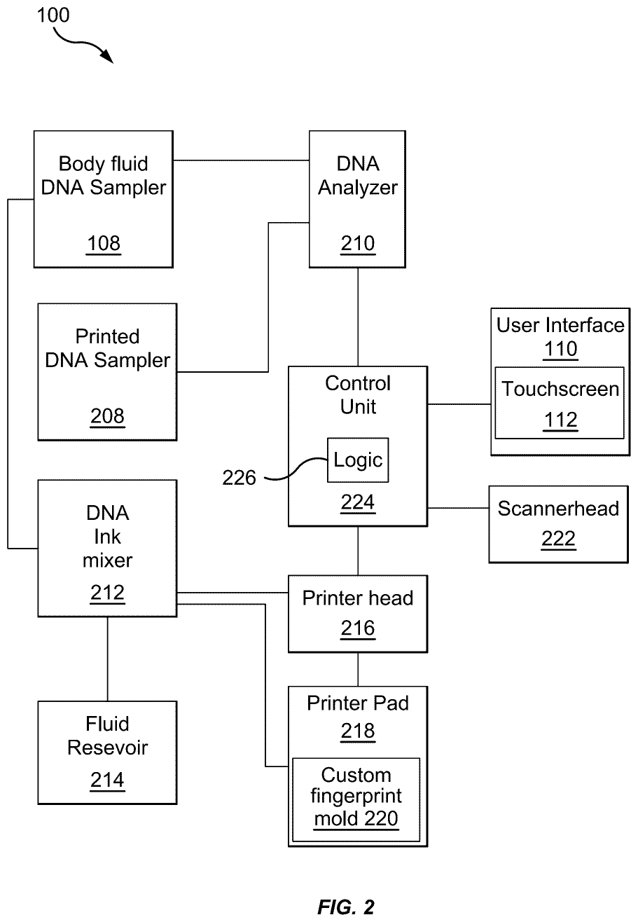

FIG. 2 is a schematic diagram illustrating the DNA fingerprint apparatus 100 according to an example. As illustrated, DNA fingerprint apparatus 100 includes the body fluid DNA sampler 108, a printed DNA sampler 208, and a DNA analyzer 210.

As described above, the body fluid DNA sampler 108 is configured to receive either a blood-type DNA sample or a saliva-type DNA sample. In some implementations a single body fluid DNA sampler 108 is configured to receive both blood-type DNA samples and a saliva-type DNA samples. In other implementations body fluid DNA sampler 108 will include a first sampler configured to receive a blood-type DNA sample and a second sampler configured to receive a saliva-type DNA sample. For example, the body fluid DNA sampler 108 may include one or more of a blood DNA sampler or a cheek swab DNA sampler.

In some implementations, the printed DNA sampler 208 is configured to sample a printed DNA infused fingerprint certificate from a document. For example, the printed DNA sampler 208 samples the printed DNA infused fingerprint certificate via physical removal of a portion of DNA infused ink from the printed DNA infused fingerprint certificate. Such removal may be performed via a mechanical scraper physically removing a portion of the DNA infused ink from the printed DNA infused fingerprint certificate. A vacuum source or tacky substance may be utilized to collect the physically removed portion of the DNA infused ink. Alternatively, such removal may be performed via a solvent applicator physically removing a portion of the DNA infused ink from the printed DNA infused fingerprint certificate via dissolution. A vacuum source or the like may be utilized to collect the physically removed portion of the DNA infused ink that has been dissolved in solvent. Once the physically removed portion of the DNA infused ink is collected, the physically removed portion of the DNA infused ink may be transferred from the printed DNA sampler 208.

As illustrated, the DNA analyzer 210 is coupled to the body fluid DNA sampler 108 and the printed DNA sampler 208. The DNA analyzer is to determine DNA sequencing of the body fluid and the printed DNA infused fingerprint certificate for comparison.

As illustrated, the DNA fingerprint apparatus 100 further includes a user interface, 110, a DNA ink mixer 212, an ink reservoir 214, a printer head 216, a print pad 218 (e.g., including a custom fingerprint mold 220), a scanner head 222, and/or a control unit 224.

As described above, the user interface 110 may include a touch screen 112. Additionally, or alternatively the user interface 110 may include a series of control buttons, the like, and/or combinations thereof. In some examples, the touch screen 112 is configured to scan a fingerprint of a user's finger.

In some implementations, the body fluid DNA sampler 108 is configured to transfer body fluid to the DNA ink mixer 212. The DNA ink mixer 212 is coupled to an ink reservoir 214. The DNA ink mixer 212 is configured to mix the body fluid from the DNA ink mixer 212 with ink from the ink reservoir 214 to form DNA infused printer ink. The DNA ink mixer 212 is coupled to printer head 216. Printer head 216 is configured to print with the DNA infused printer ink, e.g., to print the DNA infused fingerprint certificate. Additionally, or alternatively, the DNA ink mixer 212 is coupled to the print pad 218, including a custom fingerprint mold 220 or the like, to apply DNA infused printer ink to the print pad 218, with then may be applied to a document to form the DNA infused fingerprint certificate.

As described above, the user interface 110 may include a touch screen 112. Additionally, or alternatively the user interface 110 may include a series of control buttons, the like, and/or combinations thereof. In some examples, the touch screen 112 is configured to scan a fingerprint of a user's finger.

In some implementations, the scanner head is to capture an image of the printed DNA infused fingerprint certificate. Such an image may be used for identification purposes in comparison to a fingerprint obtained by touch screen 112 or from a database of fingerprints.

In some examples, the control unit 224 is coupled to the DNA analyzer 210, the printer head 216, the user interface 110, the scanner head 222, and/or other components of the DNA fingerprint apparatus 100. The control unit 224 includes logic 226. The logic may be implemented in computer readable instructions (e.g., software), configurable computer readable instructions (e.g., firmware), fixed-functionality computer readable instructions (e.g., hardware), etc., or any combination thereof. Accordingly, the control unit 224 receives information from and controls operations of the DNA analyzer 210, the printer head 216, the user interface 110, the scanner head 222, and/or other components of the DNA fingerprint apparatus 100.

As will be described in greater detail below, the control unit 224 is to compare the DNA sequencing of the body fluid to the DNA sequencing of the printed DNA infused fingerprint certificate. Further, the control unit 224 is to compare the scanned fingerprint of the user's finger to the captured image of the printed DNA infused fingerprint certificate. The control unit 224 is then to confirm a match based on the comparison of the DNA sequencing of the body fluid to the DNA sequencing of the printed DNA infused fingerprint certificate as well the comparison of the scanned fingerprint of the user's finger to the captured image of the printed DNA infused fingerprint certificate.

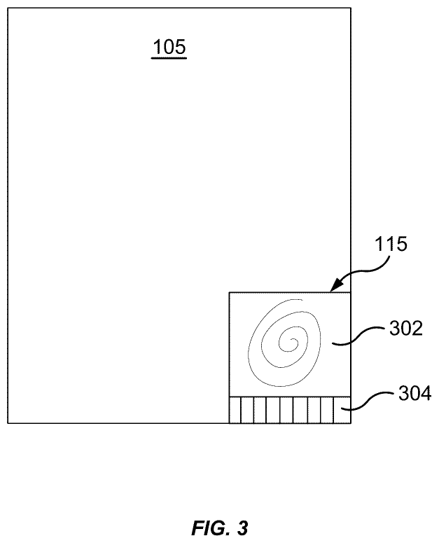

FIG. 3 is a diagram illustrating a DNA infused fingerprint certificate 300 according to an example. As illustrated, document 105 includes the DNA infused fingerprint certificate 115. The DNA infused fingerprint certificate 115 may include a finger print portion 302 and a removable tab portion 304.

As described above, the printed DNA sampler 208 is configured to sample the DNA infused fingerprint certificate 115 from the document 105. In order not to damage the finger print portion 302, the printed DNA sampler 208 may sample from the removable tab portion 304.

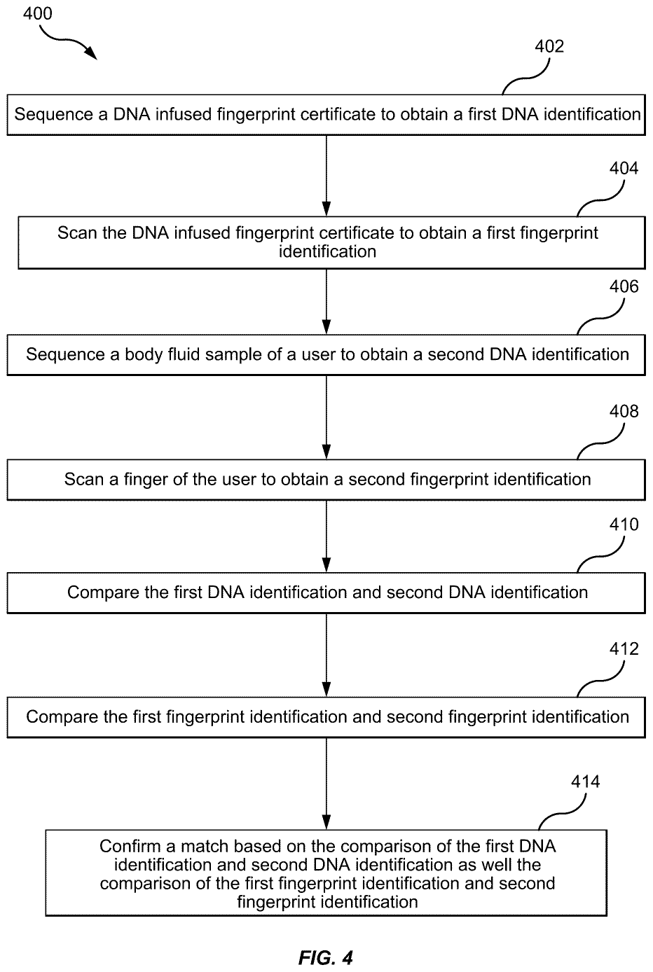

FIG. 4 shows an example method 400 for operating a DNA fingerprint scanner according to an example. The method 400 may generally be implemented in an apparatus, such as, for example, the DNA fingerprint apparatus 100 (FIGS. 1 and/or 2), already discussed.

Illustrated processing block 402 provides for sequencing a DNA infused fingerprint certificate. For example, a DNA infused fingerprint certificate is sequenced to obtain a first DNA identification.

Illustrated processing block 404 provides for scanning the DNA infused fingerprint certificate. For example, the DNA infused fingerprint certificate may be scanned to obtain a first fingerprint identification.

Illustrated processing block 406 provides for sequencing a body fluid sample. For example, a body fluid sample of a user may be sequenced to obtain a second DNA identification.

In some implementations, the body fluid sample includes a blood sample, a saliva sample, the like, and/or combinations thereof.

Illustrated processing block 408 provides for scanning a finger of the user. For example, a finger of the user may be scanned to obtain a second fingerprint identification.

Illustrated processing block 410 provides for comparing the DNA. For example, the first DNA identification and second DNA identification may be compared.

Illustrated processing block 412 provides for comparing the fingerprints. For example, the first fingerprint identification and second fingerprint identification may be compared.

Illustrated processing block 414 provides for confirming a match. For example, a match may be confirmed based on the comparison of the first DNA identification and second DNA identification as well the comparison of the first fingerprint identification and second fingerprint identification.

In an example, the method 400 may be implemented in computer readable instructions (e.g., software), configurable computer readable instructions (e.g., firmware), fixed-functionality computer readable instructions (e.g., hardware), etc., or any combination thereof.

In some examples, it will be appreciated that some or all of the operations in method 400 may be performed at least in part by cloud processing.

It will be appreciated that some or all of the operations in method 400 are described using a “pull” architecture (e.g., polling for new information followed by a corresponding response) may instead be implemented using a “push” architecture (e.g., sending such information when there is new information to report), and vice versa.

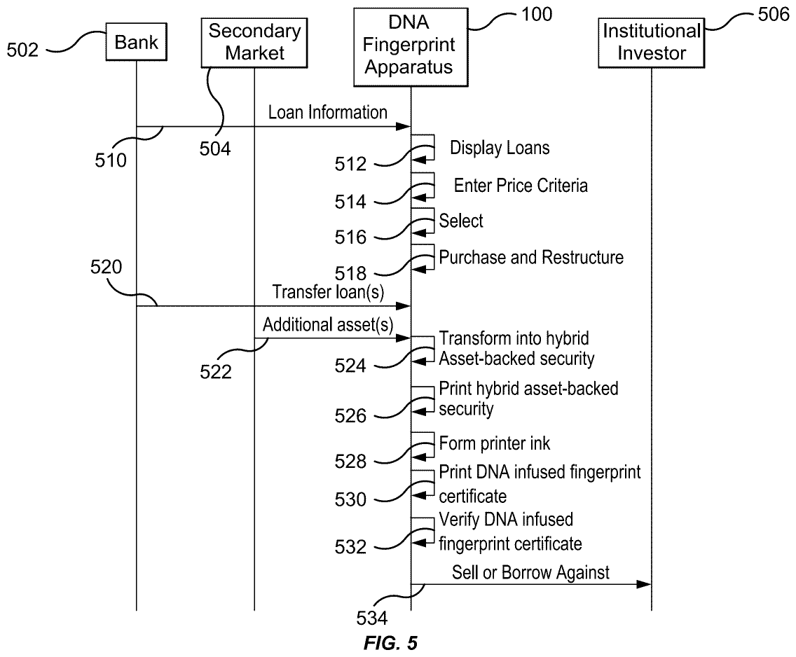

Additional details regarding method 400 are detailed below in FIG. 5.

FIG. 5 shows another example method 500 for transforming an interest-bearing loan into a hybrid asset-backed security according to an example. The method 500 may generally be implemented in an apparatus, such as, for example, the DNA fingerprint apparatus 100 (FIGS. 1 and/or 2), already discussed.

In the illustrated example, DNA fingerprint apparatus 100 is in communication with a bank 502, a secondary market 504, and an institutional investor 506. The bank 502 is any financial institution making loans, such as mortgages or the like. The secondary market 504 is any financial institution from which non-loan financial assets (e.g., a government security, a nongovernmental organization (NGO) security, stocks, bonds, commodities, mutual funds, the like, and/or combinations thereof) may be obtained. The institutional investor 506 is any financial institution from which the hybrid asset-backed security described herein might be monetized (e.g., sold or borrowed against).

As will be described in greater detail below, a hybrid asset-backed security may be created according to method 500. Such a hybrid asset-backed security creates a 0% or below-market interest rate loan. Such a hybrid asset-backed security is created from an interest-bearing loan, by combining such an interest-bearing loan with additional non-loan financial assets (e.g., a government security, a nongovernmental organization (NGO) security, stocks, bonds, commodities, mutual funds, the like, and/or combinations thereof).

As used herein the term “below-market interest rate loan” may refer to hybrid loans under the wall street prime rate or the like.

Illustrated processing block 510 provides for obtaining loan information. For example, DNA fingerprint apparatus 100 obtains loan information from bank 502.

Illustrated processing block 512 provides for displaying a plurality of loans or notes stored in an electronic database (e.g., an electronic database of bank 502), the plurality of loans or notes having face values.

Illustrated processing block 514 provides for entering a price criteria for the plurality of loans or notes. For example, the entered price criteria may be utilized to sort the plurality of loans or notes for the most relevant search results based at least in part on the price criteria. Additionally, or alternatively, different search criteria may be utilized to sort the plurality of loans or notes.

In some implementations, the price criteria is a loan to value ratio, the like, and/or combinations thereof.

Illustrated processing block 516 provides for selecting a subset of loans or notes from the plurality of loans or notes based on the price criteria. Additionally, or alternatively, different criteria may be utilized to select from the plurality of loans or notes.

Illustrated processing block 518 provides for purchasing and restructuring the subset of loans or notes. For example, the subset of loans or notes may be requested from the bank 502. Additionally, one or more additional non-loan financial assets (e.g., a government security, a nongovernmental organization (NGO) security, stocks, bonds, commodities, mutual funds, the like, and/or combinations thereof) may be requested from secondary market 504. For example, the one or more additional non-loan financial assets may include a government security (e.g. a U.S. Treasury Bond or any other negotiable specific world government instrument) or nongovernmental organization (NGO) security (e.g., a financial instrument the International Monetary Fund, World Bank, BRICS (Brazil, Russia, India, China) Development Bank, and/or the like) and a property asset (e.g., stocks, bonds, commodities, mutual funds, the like, and/or combinations thereof). As will be described below, the subset of loans or notes along with a government security or nongovernmental organization (NGO) security and a property asset may be restructured into a single hybrid financial instrument for providing 0% interest mortgages, 0% secured personal loans, or 0% secured business loans.

Illustrated processing block 520 provides for transferring the subset of loans from the bank 502.

Illustrated processing block 522 provides for transferring the additional non-loan financial assets (e.g., a government security, a nongovernmental organization (NGO) security, stocks, bonds, commodities, mutual funds, the like, and/or combinations thereof) from the secondary market 504.

Illustrated processing block 524 provides for transforming an interest-bearing loan (e.g. from the subset of loans) into the hybrid asset-backed security to offer a 0% or below-market interest rate loan. For example, such a transformation may include and culminate processing blocks 512-518 by the subset of loans or notes along with a government security or nongovernmental organization (NGO) security and a property asset being restructured into a single hybrid financial instrument for providing 0% interest mortgages, 0% secured personal loans, or 0% secured business loans.

Illustrated processing block 526 provides for printing the hybrid asset-backed security. For example, the DNA infused fingerprint certificate is printed on a hybrid asset-backed security that is a 0% or below-market interest rate loan transformed from an interest-bearing loan. Illustrated processing block 528 provides for forming DNA infused printer ink. Illustrated processing block 530 provides for printing the hybrid asset-backed security with the DNA infused fingerprint certificate.

In some implementations, printing of the hybrid asset-backed security with the DNA infused fingerprint certificate further includes use of a custom latex mold. For example, such printing may include: forming a custom latex mold of a fingerprint obtained from an authorized person; attaching the mold to a print pad mechanism of a printer; forming a DNA infused printer ink by combining a DNA material of the authorized person and a printer ink; applying the DNA infused printer ink to the mold; and printing the DNA infused fingerprint certificate on a sheet of paper via the mold with the applied DNA infused printer ink.

Alternatively, printing of the hybrid asset-backed security with the DNA infused fingerprint certificate further includes: forming a printer ink by combining a DNA material of the authorized person and a pigment ink to form DNA infused printer ink; printing the DNA infused fingerprint certificate on a sheet of paper using the DNA infused printer ink via a printer head of the DNA fingerprint printer; and printing the hybrid asset-backed security on the sheet of paper using printer ink via the printer head of the DNA fingerprint printer.

Illustrated processing block 532 provides for verifying the DNA infused fingerprint certificate. For example, please see the operations described in method 400, as described above.

Illustrated processing block 534 provides for selling or borrowing against the hybrid asset-backed security via the institutional investor 506.

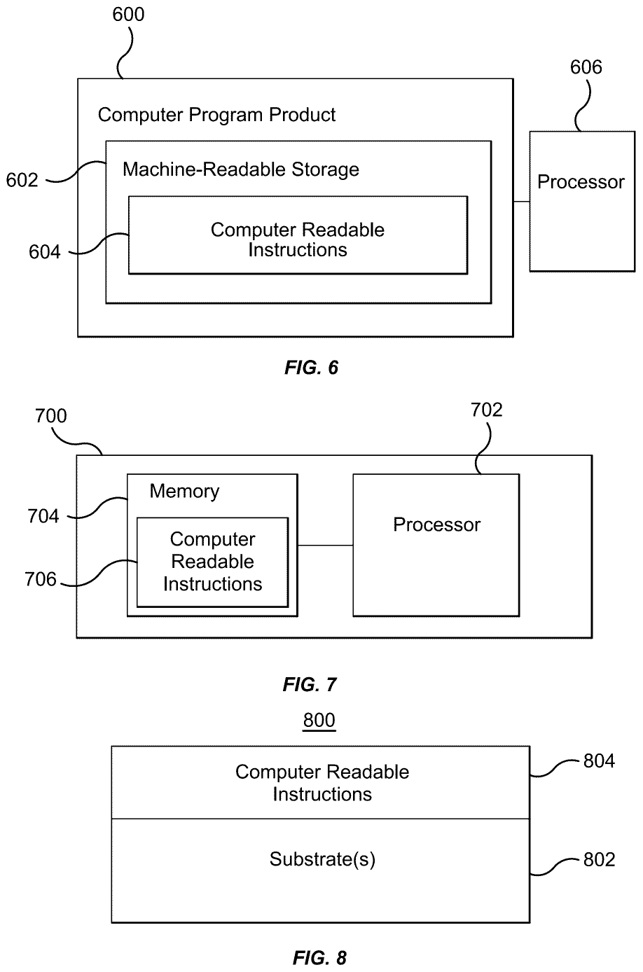

FIG. 6 illustrates a block diagram of an example computer program product 600. In some examples, as shown in FIG. 6, computer program product 600 includes a machine-readable storage 602 that may also include computer readable instructions 604. In some implementations, the machine-readable storage 602 may be implemented as a non-transitory machine-readable storage. In some implementations the computer readable instructions 604, which may be implemented as software, for example. In an example, the computer readable instructions 604, when executed by a processor 606, implement one or more aspects of the method 400 (FIG. 4) and/or the method 500 (FIG. 5), already discussed.

FIG. 7 shows an illustrative example of a computer 700. In the illustrated example, the computer 700 may include a processor 702 and a memory 704 communicatively coupled to the processor 702. The memory 704 may include computer readable instructions 706, which may be implemented as software, for example. In an example, the computer readable instructions 706, when executed by the processor 702, implement one or more aspects of the method 400 (FIG. 4) and/or the method 500 (FIG. 5), already discussed.

In some implementations, the processor 702 may include a general purpose controller, a special purpose controller, a storage controller, a storage manager, a memory controller, a micro-controller, a general purpose processor, a special purpose processor, a central processor unit (CPU), the like, and/or combinations thereof.

Further, implementations may include distributed processing, component/object distributed processing, parallel processing, the like, and/or combinations thereof. For example, virtual computer system processing may implement one or more of the methods or functionalities as described herein, and the processor 702 described herein may be used to support such virtual processing.

In some examples, the memory 704 is an example of a computer-readable storage medium. For example, memory 704 may be any memory which is accessible to the processor 702, including, but not limited to RAM memory, registers, and register files, the like, and/or combinations thereof. References to “computer memory” or “memory” should be interpreted as possibly being multiple memories. The memory may for instance be multiple memories within the same computer system. The memory may also be multiple memories distributed amongst multiple computer systems or computing devices.

FIG. 8 shows an illustrative semiconductor apparatus 800 (e.g., chip and/or package). The illustrated apparatus 800 includes one or more substrates 802 (e.g., silicon, sapphire, or gallium arsenide) and computer readable instructions 804 (such as, configurable computer readable instructions (e.g., firmware) and/or fixed-functionality computer readable instructions (e.g., hardware)) coupled to the substrate(s) 802. In an example, the computer readable instructions 804 implement one or more aspects of the method 400 (FIG. 4) and/or the method 500 (FIG. 5), already discussed.

In some implementations, computer readable instructions 804 may include transistor array and/or other integrated circuit/IC components. For example, configurable firmware logic and/or fixed-functionality hardware logic implementations of the computer readable instructions 804 may include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

All definitions, as defined and used herein, should be understood to control over dictionary definitions, definitions in documents incorporated by reference, and/or ordinary meanings of the defined terms.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples may be combined to form additional examples.

We claim:

1. A method, comprising:
sequencing, via a DNA fingerprint scanner, a DNA infused fingerprint certificate to obtain a first DNA identification;
scanning, via the DNA fingerprint scanner, the DNA infused fingerprint certificate to obtain a first fingerprint identification;
sequencing, via the DNA fingerprint scanner, a body fluid sample of a user to obtain a second DNA identification;
scanning, via the DNA fingerprint scanner, a finger of the user to obtain a second fingerprint identification;
comparing, via the DNA fingerprint scanner, the first DNA identification and second DNA identification;
comparing, via the DNA fingerprint scanner, the first fingerprint identification and second fingerprint identification; and
confirming, via the DNA fingerprint scanner, a match based on the comparison of the first DNA identification and second DNA identification as well the comparison of the first fingerprint identification and second fingerprint identification.

2. The method of claim 1, wherein the body fluid sample comprises one or more of a blood sample or a saliva sample.

3. The method of claim 1, wherein DNA infused fingerprint certificate is printed on a hybrid asset-backed security that is a 0% or below-market interest rate loan transformed from an interest-bearing loan, the method further comprising:
transforming, via one or more processors, the interest-bearing loan into the hybrid asset-backed security to offer the 0% or below-market interest rate loan; and
printing, via a DNA fingerprint printer, the hybrid asset-backed security with the DNA infused fingerprint certificate.

4. The method of claim 3, wherein the DNA fingerprint scanner and the DNA fingerprint printer form a single apparatus.

5. The method of claim 3, wherein the transforming, via one or more processors, the interest-bearing loan into the hybrid asset-backed security further comprises:
displaying, using one or more processors, a plurality of loans or notes stored in an electronic database, the plurality of loans or notes having face values;
entering, using one or more of the processors, a price criteria for the plurality of loans or notes;
selecting, using one or more of the processors, a subset of loans or notes from the plurality of loans or notes based on the price criteria; and
purchasing and restructuring, using one or more of the processors, the subset of loans or notes along with a government security or nongovernmental organization (NGO) security and a property asset into a single hybrid financial instrument for providing 0% interest mortgages, 0% secured personal loans, or 0% secured business loans.

6. The method of claim 5, wherein the price criteria is a loan to value ratio.

7. The method of claim 5, wherein the property asset is one or more of a stock asset or a commodity asset.

8. The method of claim 3, wherein the printing, via the DNA fingerprint printer, of the hybrid asset-backed security with the DNA infused fingerprint certificate further comprises:
forming a custom latex mold of a fingerprint obtained from an authorized person;
attaching the mold to a print pad mechanism of a printer;
forming a DNA infused printer ink by combining a DNA material of the authorized person and a printer ink;
applying the DNA infused printer ink to the mold; and
printing the DNA infused fingerprint certificate on a sheet of paper via the mold with the applied DNA infused printer ink.

9. The method of claim 3, wherein the printing, via the DNA fingerprint printer, of the hybrid asset-backed security with the DNA infused fingerprint certificate further comprises:
forming a printer ink by combining a DNA material of the authorized person and a pigment ink to form DNA infused printer ink;
printing the DNA infused fingerprint certificate on a sheet of paper using the DNA infused printer ink via a printer head of the DNA fingerprint printer; and
printing the hybrid asset-backed security on the sheet of paper using printer ink via the printer head of the DNA fingerprint printer.

10. A DNA fingerprint apparatus, comprising:
a body fluid DNA sampler to receive body fluid;
a printed DNA sampler to sample a printed DNA infused fingerprint certificate; and
a DNA analyzer coupled to the body fluid DNA sampler and the printed DNA sampler, the DNA analyzer to determine DNA sequencing of the body fluid and the printed DNA infused fingerprint certificate.

11. The DNA fingerprint apparatus of claim 10, wherein the body fluid DNA sampler comprises one or more of a blood DNA sampler or a cheek swab DNA sampler.

12. The DNA fingerprint apparatus of claim 10, wherein the printed DNA sampler samples the printed DNA infused fingerprint certificate via physical removal of a portion of DNA infused ink from the printed DNA infused fingerprint certificate.

13. The DNA fingerprint apparatus of claim 10, further comprising a touch screen to scan a fingerprint of a user's finger.

14. The DNA fingerprint apparatus of claim 10, further comprising a scanner head to capture an image of the printed DNA infused fingerprint certificate.

15. The DNA fingerprint apparatus of claim 10, further comprising:
a touch screen to scan a fingerprint of a user's finger;
a scanner head to capture an image of the printed DNA infused fingerprint certificate; and
a control unit to:
compare the DNA sequencing of the body fluid to the DNA sequencing of the printed DNA infused fingerprint certificate;
compare the scanned fingerprint of the user's finger to the captured image of the printed DNA infused fingerprint certificate; and
confirm a match based on the comparison of the DNA sequencing of the body fluid to the DNA sequencing of the printed DNA infused fingerprint certificate as well the comparison of the scanned fingerprint of the user's finger to the captured image of the printed DNA infused fingerprint certificate.

16. The DNA fingerprint apparatus of claim 10, further comprising:
a DNA ink mixer to mix the body fluid with printer ink to form DNA infused ink; and
a print head to print with the DNA infused printer ink.
